(19) United States
(12) Patent Application Publication
(10) Pub. No.: US 2026/0202533 A1
(43) Pub. Date: Jul. 16, 2026

(54) Hybrid Interferometer and Method of Using the Same

(71) Applicant: Propagation Research Associates, LLC, Marietta, GA (US)

(72) Inventor: Ernest Jefferson Holder, Canton, GA (US)

(21) Appl. No.: 19/448,092

(22) Filed: Jan. 13, 2026

Related U.S. Application Data
(60) Provisional application No. 63/744,822, filed on Jan. 13, 2025.

(51) Int. Cl. G01S 13/44; G01S 7/28

(52) U.S. Cl. CPC G01S 13/4418; G01S 7/2813; G01S 13/4481

(57) ABSTRACT

Systems and methods are presented. The systems include a hybrid interferometer that implements both monopulse and interferometry modes to determine angle of arrival of target signals using one or more separate receive antenna elements (SSRAE), the SSRAE receiving T unique waveforms transmitted from a set of at least two transmit antenna elements (SSTAE), and a circuit assembly electrically coupled to the set of SSRAE, the set of SSRAE providing respective electrical signals responsive to the T unique waveforms, the circuit assembly operating on the respective electrical signals to define a set of T weights to apply to the T unique waveforms. A method includes arranging a set of SSRAE, receiving T unique waveforms transmitted from a set of at least two SSTAE with at least one of the SSRAE, and spatially manipulating lobes generated by the respective T unique waveforms as received by the at least one receive antenna element.

### CROSS-REFERENCE TO RELATED APPLICATIONS

This utility patent application claims the benefit of the filing date of the Provisional Patent Application No. 63/744,822, filed on Jan. 13, 2025, the disclosure of which is incorporated herein by reference in its entirety.

### TECHNICAL FIELD

Embodiments of the disclosure relate to radio-frequency interferometry and a manufacturing method.

### TECHNOLOGICAL BACKGROUND

RF interferometry uses distributed aperture antenna architectures to enhance the angle precision of the radar by increasing the aperture dimension with only a few moderately sized antennas. These architectures provide increased accuracy at a reduction in cost compared to fully populating the entire array with antennas. However, the penalty is that by operating with fewer and smaller antennas the sensitivity of the interferometric architecture suffers since there is less total power-aperture (transmit power×transmit antenna gain×receive antenna gain) when compared to a fully populated array. For example, a Conventional Interferometer (CI) uses a single transmit antenna with multiple distributed receive antennas. The total power-aperture for a conventional interferometer is limited to the power-aperture of each antenna. The size of the single CI transmit antenna can be made larger than the receive antennas to increase the total CI power aperture, but this increases the size and cost of the transmit antenna. An Orthogonal Interferometer (OI) uses unique waveforms transmitted and received from distributed antennas which limits the OI total power-aperture to the power-aperture of each antenna. However, while there are multiple distributed transmit antennas, these antennas cannot all be increased in size without a significant impact on the size and cost of the OI array. Of course, OI can achieve twice the improvement in precision compared to CI at the penalty of increasing the number of transmit/receive antennas.

### SUMMARY

There may be a need to provide a higher power aperture in an interferometer array using smaller distributed apertures.

A hybrid interferometer and a method are described.

According to an embodiment of the present disclosure, there is described a system in the form of a hybrid interferometer that includes a set of spatially separated receive antenna elements (SSRAE), the SSRAE having at least R members, where R is a positive integer greater than or equal to one, the SSRAE receiving T unique waveforms transmitted from a set of separate transmit antenna elements (SSTAE), the SSTAE having at least T members transmitting T unique waveforms, respectively, where T is a positive integer greater than or equal to two; and a circuit assembly electrically coupled to the set of SSRAE, the set of SSRAE providing respective electrical signals responsive to the T unique waveforms, the circuit assembly operating on the respective electrical signals to define a set of T weights to apply to the T unique waveforms to create a combined waveform from the T received waveforms at each of the R receive antennas, where the R combined waveforms are the coherent sum of the T waveforms at each of the R members of the SSRAE.

According to this embodiment a hybrid interferometer is capable of implementing monopulse modes and various interferometer nodes in the same antenna architecture to determine angle of arrival of a signal received at SSRAE.

According to a further aspect of the present disclosure, there is described a method including: arranging a set of spatially separated receive antenna elements (SSRAE), the SSRAE having at least R members, where R is a positive integer greater than or equal to one, the SSRAE receiving T unique waveforms transmitted from a set of separate transmit antenna elements (SSTAE), the SSTAE having at least T members transmitting T unique waveforms, respectively, where T is a positive integer greater than or equal to two; and spatially manipulating lobes generated by the respective T unique waveforms.

Spatially manipulating lobes generated by the respective T unique waveforms includes applying a respective spatial weight to direct the respective T unique waveforms with respect to a transmit normal vector extending orthogonally from a plane defined by the SSTAE. The respective spatial weight is applied in a manner that directs the respective lobes to a desired angle with respect to a transmit normal vector extending from the plane defined by the SSTAE such that the lobes converge at a desired range from an origin of the transmit normal vector. When the desired angle and the desired range coincide with the location of a target in a transmit field of view, the power of a respective receive signal incident at the SSRAE is at a maximum.

### Overview of Embodiments

The SSRAE defines a receive plane with a normal vector extending orthogonally from the receive plane. The SSTAE defines a transmit plane with a respective normal vector extending orthogonally from the transmit plane. The receive plane and the transmit plane may or may not be co-located. When the receive plane and the transmit plane are co-located the respective receive plane and transmit plane will be coplanar.

In an embodiment of the hybrid interferometer respective circuit assemblies are coupled to the SSTAE and to the SSRAE. The circuit assembly coupled to the SSTAE will include a waveform generator that generates a unique signal for each transmit antenna. Each unique signal will include a characteristic that can be separately identified by a matched filter arranged for that purpose. Such a matched filter may be arranged in or in communication with the circuit assembly coupled to one or both of the SSTAE and the SSRAE. The circuit assembly coupled to the SSTAE will further include a reference clock which will be used by the respective circuit assembly coupled to the SSRAE using one or more signal processing routines to determine the time of arrival of a combined waveform at each member of the set of SSRAE, to identify each of the T unique waveforms and its phase, as well as to determine a sequence of range resolution cells over a window and an angle of incidence of the received versions of the T unique waveforms with respect to a normal vector extending from a receive plane defined by the SSRAE.

When a target is present in a field of view in an environment surrounding the SSRAE and SSTAE, the electrical signals include information responsive to a reflected version of the T unique transmit waveforms emitted by the SSTAE. When appropriately arranged, the circuit assembly uses phase information from the R combined waveforms to determine an angle of arrival of the target signal with respect to a normal vector extending orthogonally from the respective plane defined by the SSRAE or SSTAE.

In an embodiment, a circuit assembly coupled to the SSRAE is arranged to use a monopulse architecture using at least a single member of the set of SSRAE to form an angle of arrival of the target signal with respect to the normal vector extending orthogonally from the transmit plane.

In such an embodiment, the circuit assembly coordinates both transmit nodes and a receive node to increase sensitivity and to resolve analog and digital grating lobes generated in the observable field of view. A monopulse estimate of angle of arrival may be applied to resolve the analog and digital interferometry grating lobes.

In an embodiment, the circuit assembly coordinates the transmit nodes and does not coordinate the receive nodes to provide a mid-range sensitivity and to increase the precision of the angles measured.

In an embodiment, the respective electrical signals define at least two sets of R weights to create at least one or more pairs of sum and difference weights for applying one or more monopulse ratios of a difference divided by a sum to determine the angle of arrival of the target with respect to the normal vector extending orthogonally from the receive plane.

In an embodiment where the SSRAE and the SSTAE are not collocated, the circuit assembly uses the set of T weights from the T combined waveforms received at each of at least one of the R members of the SSRAE to determine an angle of arrival of the combined transmitted waveforms from the SSTAE with respect to the normal vector extending orthogonally from the transmit plane.

In an embodiment of the hybrid interferometer, the transmit signals from the SSTAE are spatially weighted to direct the transmit signals with waveform coherence with respect to the normal vector extending orthogonally from the transmit plane. Information responsive to the orientation of the SSTAE, SSRAE, and a target in a transmit signal field may be determined by a circuit assembly coupled to the SSTAE, a respective circuit coupled to the SSRAE, or both.

In one arrangement, a beam scanning routine may be directed by the circuit assembly coupled to the SSTAE and when a reflected signal indicative of the presence of a target is identified in a transmit field, the circuit assembly coupled to the SSTAE may determine a range to the target and a transmit angle of the scanned signal with respect to a transmit normal vector to identify the location of the target in a three-dimensional space.

In an alternative embodiment of the hybrid interferometer, incident signals at the SSRAE are spatially weighted to increase sensitivity with respect to the normal vector extending orthogonally from the receive plane. In this received version of beam steering a target may be identified at a greater distance from the origin of a vector extending from the receive plane. However, interferometry is no longer possible since the received T unique waveforms are combined.

In another alternative embodiment of the hybrid interferometer the circuit assembly coupled to the SSRAE determines a value or weight to spatially manipulate lobes generated by the respective T unique waveforms. The respective values or weights to be applied to the T unique waveforms at the SSTAE is responsive to a reflected version of the T unique waveforms received at one of the members of the set of SSRAE. In this alternative embodiment, the values or weights are communicated to the SSTAE from the circuit coupled to the SSRAE to provide transmit signal beam steering toward the target. Once the SSTAE is “hitting” the target, one or more tracking techniques can be deployed by the circuit assembly coupled to the SSTAE and the circuit coupled to the SSRAE can be configured to determine range and angle of incidence of the reflected versions of the T unique waveforms.

In an embodiment, a track manager communicatively coupled to the circuit assembly or integrated within the circuit assembly is arranged to pair a defined mode of operation of the circuit assembly with a detected target, wherein the defined mode of operation is selected from the group of modes consisting of a maximally cohered array monopulse, maximally cohered array interferometer, orthogonal interferometry, and conventional interferometry.

A hybrid interferometer can be deployed when the SSRAE are not co-located with the SSTAE.

However, the hybrid interferometer is still operational when the SSRAE is co-located with the SSTAE.

In an embodiment, when the respective electrical signals include at least one target signal, the circuit assembly uses the unique waveforms and voltages determined from the electrical signals from the unique waveforms to define one or more pairs of sum and difference phase weightings applied to the voltages at each of the T members of the SSTAE resulting from the T combined waveforms at each R member for defining one or more monopulse ratios of a difference beam voltage divided by a sum beam voltage that determines the angle of arrival of the target signal with respect to the normal vector extending orthogonally from the transmit plane.

In an embodiment, when the respective electrical signals include at least one target signal, the circuit assembly uses voltages determined from the electrical signals to define one or more pairs of sum and difference phase weightings applied to the voltages at each of the R members of the SSRAE resulting from the T combined waveforms at each R member for defining one or more monopulse ratios of a difference beam voltage divided by a sum beam voltage that determines the angle of arrival of the target with respect to the normal vector extending orthogonally from the receive plane.

An embodiment of a method for increasing the sensitivity of a conventional interferometer includes arranging a set of spatially separated receive antenna elements (SSRAE), the SSRAE having at least R members, where R is a positive integer greater than or equal to one, the SSRAE receiving T unique waveforms transmitted from a set of spatially separated transmit antenna elements (SSTAE), the SSTAE having at least T members transmitting T unique waveforms, respectively, where T is a positive integer greater than or equal to two; and spatially manipulating lobes generated by the respective T unique waveforms.

In this alternative embodiment, spatially manipulating lobes generated by the respective T unique waveforms includes applying a respective spatial weight to direct the respective T unique waveforms with respect to a transmit normal vector extending orthogonally from a plane defined by the SSTAE. The respective spatial weight is applied in a manner that directs the respective lobes to a desired angle with respect to the transmit normal vector extending from the plane defined by the SSTAE and such that the lobes converge at a desired range from an origin of the transmit normal vector.

When the desired angle and the desired range coincide with the location of a target in a transmit field of view, the power of a respective receive signal incident at the SSRAE is at a maximum.

The method may further include coupling a circuit assembly to the set of SSRAE and arranging the circuit assembly with up to T matched filters. In such configurations the transmit spatial weight is a function of an output of the T matched filters. Here the set of SSRAE provide respective electrical signals responsive to the T unique waveforms, the circuit assembly operating on the respective electrical signals to define a range from the target to an origin of a normal vector extending from the plane defined by the SSRAE and an estimate of an angle of incidence with respect to a receive normal vector extending from the plane defined by the SSRAE.

The method may further include arranging the circuit assembly with up to T matched filters. When so arranged, the circuit assembly uses the voltage outputs from the up to T matched filters at each R member of the SSRAE to determine an angle of arrival interferometrically. These determinations of the angle of arrival are responsive to phase measurements of the voltages at the outputs of the T matched filters. Alternatively, a monopulse technique can be applied to the voltage outputs from the up to T matched filters at each R member of the SSRAE to determine an angle of arrival. In this alternative method, the angle of arrival is responsive to sum and difference ratios of voltages.

In an embodiment, spatially manipulating lobes generated by the respective T unique waveforms includes applying a respective spatial weight to direct the respective T unique waveforms with respect to a transmit normal vector extending orthogonally from a plane defined by the SSTAE.

In this embodiment, the respective spatial weight is applied in a manner that directs the respective lobes to a desired angle with respect to the transmit normal vector extending from the plane defined by the SSTAE such that the lobes converge at a desired range from an origin of the transmit normal vector.

Still further when operating in this embodiment a circuit assembly coupled to the SSRAE and receiving the respective electrical signals responsive to the T unique waveforms can determine a range from the target to an origin of a normal vector extending from the plane defined by the SSRAE and an estimate of an angle of incidence with respect to a receive normal vector extending from the plane defined by the SSRAE.

A circuit assembly coupled to the SSTAE is arranged to operate in multiple modes to support target detection and to adjust target track accuracy. Each of these operational modes will vary in sensitivity and angle accuracy. A hierarchy of operational modes is envisioned.

For example, the methods described may further include integrating or communicatively coupling a track manager to the circuit assembly. The track manager being configured to pair a defined mode of operation of the circuit assembly with a detected target. The defined mode of operation may be selected from a group of operational modes consisting of a maximally cohered array monopulse, maximally cohered array interferometer, orthogonal interferometry, and conventional interferometry. Under some conditions it may be beneficial to mix two modes of operation.

In an example embodiment, the circuit assembly is configured to provide the described modes of operation. In an alternative embodiment, a track manager is arranged to provide the described modes of operation.

A MCAM mode of operation has the highest sensitivity and can be used to detect a target at maximum range. Although, in general, monopulse techniques do not provide the angle resolution accuracy of interferometry, monopulse is sufficiently accurate in the MCAM mode at threshold ranges to meet desired goals due to the higher target signal to noise ratios. The circuit assembly can be arranged to start tracking targets at threshold ranges using the MCAM mode. For enhanced sensitivity, all transmit antenna elements or nodes and all receive antenna elements or nodes are cohered (directed to respective angles where received signals reflected from a specific target is at a maximum power level) to increase the power aperture by a factor of

$${N}_{T}^{2} {N}_{R}$$

where N_{T} is the number of transmit nodes and N_{R} the number of receive nodes. This increase is due to the following relationship, MCAM Power-Aperture=N_{T}×P_{T}×N_{T}×G_{T}×G_{R}, where P_{T}, G_{T}, and G_{R} are the single node transmit power, transmit gain, and receive gain. For four transmitting and receiving (T/R) nodes the increase in sensitivity is 12 dB compared to a single T/R node providing a factor of 2 increase in range over the single node. The MCAM mode angle precision standard deviation can take advantage of the number T/R nodes as follows,

$${σ}_{S A M} = \frac{0.5 λ}{\frac{π}{2} D \sqrt{2 {N}_{T}^{2} {N}_{R} S N {R}_{Δ}}} = \frac{λ}{2 π D \sqrt{{N}_{T}^{2} {N}_{R} S N R}}$$

For four T/R nodes the above equation becomes,

$${σ}_{S A M} = \frac{λ}{2 π D \sqrt{64 SNR}} = \frac{λ}{16 π D \sqrt{S N R}}$$

Here the factor of 16 in the denominator provides additional accuracy required to achieve desired requirements for threshold ranges over the total required scan volume. Cohering a Maximally Cohered Array Interferometer (MCAI) on transmit and receive operations creates grating lobes that can be resolved using a monopulse architecture implemented on a contiguous subarray architecture tracking the target. Target position data from the contiguous subarray architecture can also be used to steer the MCAM cohered beam.

A MCAI mode of operation coheres the transmitting nodes but does not cohere the receiving nodes to implement interferometry with the multiple receiving nodes. As such the circuit assembly receives only the N_{T} increase in sensitivity due to the increase in power and gain for the combined transmitting nodes. For four nodes the increase is 12 dB which effectively doubles the range of operating with a single node. The angle precision for the MCAI is as follows,

$${σ}_{SAI} = \frac{λ}{2 π D \sqrt{{N}_{T}^{2} S N R}} = \frac{λ}{2 π {DN}_{T} \sqrt{S N R}}$$

Note the improvement in precision due to the number of transmitting nodes. When using four transmitting and receiving nodes, four independent MCAI modes can be implemented in the circuit assembly. All four MCAI mode transmit beams can be steered during a pulse repetition interval assuming that interleaving the pulses can be accommodated by duty requirements of the circuit assembly. The MCAI mode can operate at ranges up to 70% of the maximum range of MCAM providing enhanced accuracy over OI and CI.

In an OI mode of operation, the circuit assembly can transmit different waveforms from each transmit node. By transmitting orthogonal waveforms each waveform can be separated at the receiver where the phase measurements reflect the two-way path of the signals. As a result, the sensitivity is defined by the path of one transmitting node to the target and back to one receiving node. The two-way phase rotation results in the OI achieving a factor of 2 in angle precision improvement relative to a conventional interferometer as shown below,

$${σ}_{OI} = \frac{λ}{4 π D \sqrt{S N R}}$$

The OI mode can be used at target ranges less than 35% of maximum range and still provide enhanced accuracy over a conventional interferometer.

In the example embodiment and using a CI mode of operation, the circuit assembly can implement four independent conventional interferometers. Again, the sensitivity is defined by the path of one transmitting node to the target and back to one receiving node. Since the circuit assembly will have N number of T/R nodes the architecture will support up to N number of CI systems. The precision of each CI system is as follows.

$${σ}_{CI} = \frac{λ}{2 π D \sqrt{S N R}}$$

Note that the CI precision is larger by a factor of 2 than when using the OI mode. For four T/R nodes the system will support four CI architectures. The sensitivity of CI is the same as in the OI mode since both can transmit from one node and receive from one node. However, having four independent CI systems allows for the engagement of four simultaneous targets or having four independent measurements for improving target tracking.

A track manager coupled to the circuit assembly or integrated within the circuit assembly capable of effectively pairing modes with targets and will select optimal waveforms for the engagements. For targets that need to be engaged at maximum range the track manager will select the MCAM mode since that mode will have the most sensitivity. The track manager can select the MCAI mode for improved track accuracy at 70% of maximum range of the MCAM mode. The OI and CI modes can operate at 35% of max range with the OI mode providing enhanced accuracy over CI but by using an OI architecture CI can provide multiple instantiations. The track manager will provide an intelligent track management process that will maximize engagement accuracy by controllably managing the operating mode(s) to adjust sensitivity at ranges given the threat characteristics.

Table 1 shows the four track architecture modes that can be implemented with the circuit assembly. As can be seen the circuit assembly provides a number of diverse track architecture options. Each option has unique capabilities that can optimize performance. The first two modes, MCAM and MCAI, will provide the longest-range coverage. The last two modes, OI and CI, can be implemented at ranges less than 35% of maximum range of the MCAM mode using enhanced accuracy with OI and baseline accuracy with CI but with multiple simultaneous CI modes. The modes can also be mixed and matched when engaging multiple simultaneous targets. For example, the MCAM mode can operate simultaneously with the CI mode by interleaving optimally designed transmit pulses. If orthogonal waveforms are implemented, then MCAI can operate with orthogonal waveforms simultaneously with OI. Orthogonal waveforms can also be used to enable a self-track mode where interceptors can self-track in an inertial frame defined by the transmit array.

One difference in modes is that MCAM and MCAI create analog grating lobes in the far field due to cohering on transmit, whereas OI and CI create digital angle ambiguities. Digital ambiguities can be efficiently resolved by processing updated target information from the transmit antenna array. Analog grating lobes must be dealt with using beam steering to maintain energy on the target which requires a localized search. One reason to implement OI and CI is that these modes do not require this localized search making it more straightforward to track targets at closer ranges where angle rates can be higher. At longer ranges where angle rates are typically lower, the localized track is more effective and accommodates implementation of MCAM and MCAI. It is also possible to use orthogonal waveforms with MCAM and MCAI to facilitate the local search.

TABLE 1
Comparative Assessment of Track Modes in Order of Engagement Range

| | Transmit | Receive | | | Max Range | Number of |
|---|---|---|---|---|---|---|
| Mode | Phase | Phase | Sensitivity | Accuracy | Compared | Independent |
| Type | Nodes | Nodes | Relative to CI | Compared to CI | to MCAM | Instantiations |
| MCAM | N_{T} | N_{R} | ${N}_{T}^{2} {N}_{R}$ | $\sqrt{\frac{1}{{N}_{T}^{2} {N}_{R}}}$ | 100% | 1 |
| MCAI | N_{T} | N_{R} | ${N}_{T}^{2}$ | $\frac{1}{{N}_{T}}$ | 70% | 4 |
| OI | 1 | 1 | 1 | $\frac{1}{2}$ | 35% | 1 |
| CI | 1 | 1 | 1 | 1 | 35% | 4 |

The self-track mode will require the receiver/processor to be located on a platform, but the advantage is that a circuit assembly at the transmit antenna is not required to track the platform with any degree of accuracy and the receiver/processor complexity may be significantly reduced when compared with traditional semi-active or active seekers. Self-track mode can also include a data link enabled by the orthogonal waveforms. Self-track technology could provide additional system enhancement for a multiple mode system.

### BRIEF DESCRIPTION OF THE DRAWINGS

FIG. 1A shows an example of a transmit and receive antenna arrangement for a conventional interferometer with a transmit antenna and four receive antennas.

FIG. 1B shows an example of a transmit and receive antenna arrangement for an orthogonal interferometer with four co-located transmit and receive antennas.

FIG. 2 shows an example of signal geometry for a hybrid interferometer with two transmit antennas and two receive antennas.

FIG. 3 is a schematic diagram of an example embodiment of the transmit array of FIG. 2.

FIG. 4 is a schematic diagram illustrating an alternative embodiment of the SSTAE front end of FIG. 3.

FIG. 5 is a schematic diagram illustrating an example embodiment of a SSRAE circuit assembly in communication with the receive array of FIG. 2.

FIG. 6 is a flow diagram illustrating a method deploying a hybrid interferometer.

FIG. 7 is a flow diagram illustrating an alternative method for using a hybrid interferometer.

### DETAILED DESCRIPTION OF ILLUSTRATED EMBODIMENTS

The illustrations in the drawings are schematically presented. In different drawings, similar or identical elements are provided with the same reference signs.

Hybrid Interferometry (HI) is a hybrid of both CI and OI but allows the transmit waveforms to be spatially aligned for maximum coherence thereby providing the total power-aperture of the multiple combined transmit antennas. The concept can be described as OI on transmit and CI on receive but with the added benefit of aligning the OI waveforms to maximize power aperture. For OI the transmit waveforms are each unique with the quality that the cross correlation in a mis-matched filter is significantly lower than the autocorrelation of the matched filter for any of the waveforms. As such the OI waveforms are sometimes referred to as orthogonal waveforms, hence the term Orthogonal Interferometer. Each individual waveform creates spatial grating lobes, however when the waveforms are transmitted coherently the far field antenna pattern is modulated by the orthogonal waveforms and appears to be almost random. If the waveforms are spatially weighted to steer their individual lobes to a specific angle and range or distance from the origin of the normal vector extending from the transmit plane then the random distribution of power in the far field organizes into a grating lobe structure steered at that specific angle and range where the signal power is increased proportionally by the number of transmit antennas. This increase provides additional sensitivity to the Hybrid Interferometer using a conventional interferometer architecture on receive with orthogonal transmit waveforms. As a result, the precision of the HI is the equivalent to that of OI for two transmit and two receive antennas.

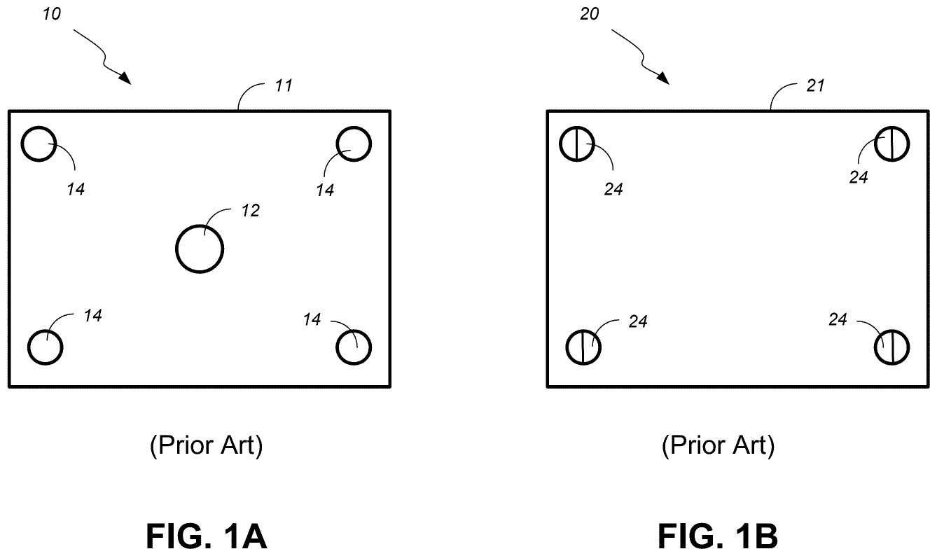

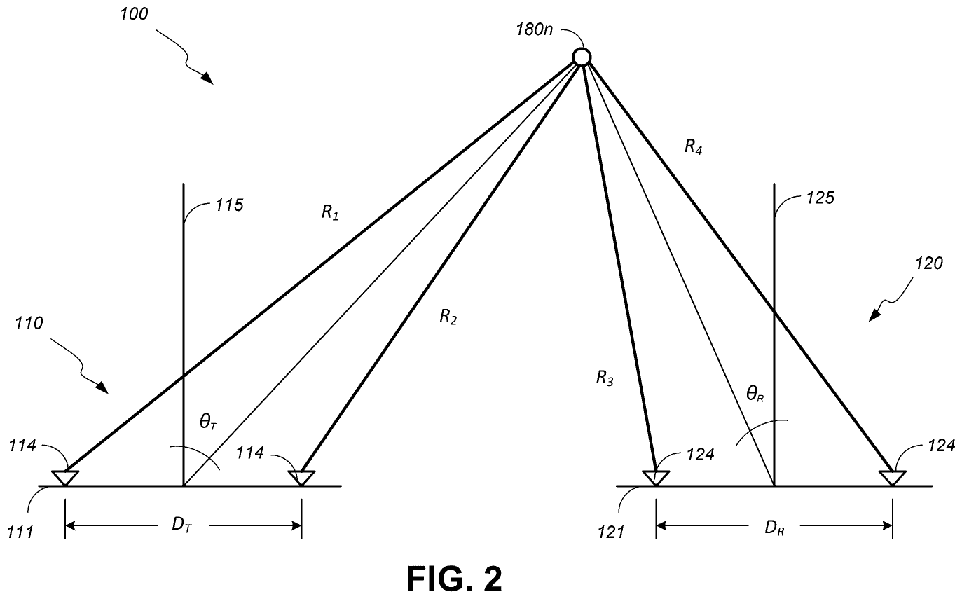

The one-dimensional interferometer angle precisions (s_{q}) for two distributed antennas separated by a distance D is defined by the following equations.

$${s}_{q}^{CI} = \frac{l}{2 pD \sqrt{{SNR}_{CI}}} Conventional Interferometer Angle Precision$$

$${s}_{q}^{OI} = \frac{l}{4 pD \sqrt{S N {R}_{OI}}} Orthogonal Interferometer Angle Precison$$

where λ is the RF signal wavelength and SNR is the signal-to-noise power ratio of the signal at each of the antenna/receivers. FIG. 1 shows a diagram of two-dimensional CI and OI architecture. The architectures of the transmit antennas are illustrated in two-dimensions for simplicity of illustration. However, it should be understood the antennas are deployed in three-dimensional coordinate systems defined by the two-dimensional plane of the set of transmit antennas and a normal vector extending from the two-dimensional plane as illustrated in FIG. 2.

As illustrated in FIG. 1A, a conventional interferometer antenna architecture 10 may include a single transmit antenna 12 surrounded by a set of two or more receive antennas 14. In the illustrated embodiment, the set of receive antennas 14 includes four spatially separated antennas. The single transmit antenna 12 is centrally located with respect to the set of receive antennas 14. As further shown in the illustrated embodiment, the transmit antenna 12 is preferably relatively larger in surface area than the respective surface area of each of the receive antennas 14. However, this relationship is not necessarily satisfied for all workable embodiments. It is further noted that while the set of four receive antennas 14 are arranged proximal to the respective corners of a rectangular transmit plane 11, other numbers of antennas may be arranged in alternative spatial relationships including arrangements where two or more transmit antennas 12 abut one another as may be desired.

As illustrated in FIG. 1B, an orthogonal interferometer antenna architecture 20 may include a set of two or more co-located and coplanar antennas 24 that operate in both transmit and receive modes of operation. While the illustrated arrangement includes a set of four transmit/receive antennas 24 other numbers of transmit/receive antennas may be arranged along a plane 21. In preferred embodiments both transmit antennas and receive antennas are separated spatially from one another. When an individual transmit/receive antenna 24 is arranged with a plurality of sub elements it may be case that a set of transmit/receive antennas 24 may contain adjacent members that abut one another. Such arrangements represent an edge case of a spatially separated array of antenna elements 24. Additionally it should be recognized, while the set of four transmit/receive antennas 24 are arranged proximal to the respective corners of the plane 21, other numbers of antennas may be arranged in alternative spatially separated relationships as may be desired.

The factor of 2 improvement of OI compared to CI is due to the two-way phase rotation resulting from OI signal propagation for unique transmit and receive paths for each antenna compared to the one-way propagation for CI where the receive path to the distributed receivers is unique but the transmit path is common since CI has only one transmit antenna. However, for CI the transmit antenna can be larger than the receive antennas thereby increasing the transmit power and/or gain depending on the antenna type which will enhance the SNR. For example, for a phased array antenna the area of the antenna can be increased by a factor of 2 providing a factor of 2 increase in both power and gain that increases the SNR by a factor of 4 for CI. This factor of 4 increase to the SNR will equalize the precision standard deviation equations as in the equations below.

$${s}_{q}^{CI} = \frac{l}{2 pD \sqrt{S N {R}_{CI}}} = \frac{l}{2 pD \sqrt{4 S N {R}_{OI}}} = \frac{l}{4 pD \sqrt{S N {R}_{OI}}} = {s}_{q}^{Ol}$$

FIG. 2 schematically illustrates an example signal geometry for a hybrid interferometer 100 with a transmit array 110 and a receive array 120 where the respective antenna architectures are not co-located. Two transmit antennas 114 of the transmit array 110 are separated spatially from two receive antennas 124 of the receive array 120. The respective transmit antennas 114 are separated from one another by a distance D_{T} and the respective receive antennas 124 are separated from one another by a distance D_{R}. The two transmit antennas are arranged on a transmit plane 111 that defines a transmit normal vector 115 that extends orthogonally from an origin of a coordinate system defined by the transmit antenna architecture. The two receive antennas 124 are arranged on a receive plane 121 that defines a receive normal vector 125 that extends orthogonally from a centroid of the receive plane 121.

In the illustrated arrangement the distance D_{T} and the distance D_{R} are approximately the same. In alternative embodiments the distance D_{T} and the distance D_{R} may be different.

The transmit antennas 114 are each transmitting a unique signal with a signal characteristic that when received and processed by a matched filter will identify respective orthogonally arranged signals that are transmitted in a transmit field that includes one or more targets where a particular target 180n where the transmit signals can be described by the following equations, s_{T}_{₁}=A_{T} exp(2pjR₁/l)W₁; s_{T}_{₂}=A_{T} exp(2pjR₂/l)W₂, where R₁ and R₂ are the respective ranges from each transmit antenna 114 to the target, W₂ and W₂ are the two orthogonal waveforms, and A_{T} is the signal amplitude defined by A_{T}=\sqrt{P_{T}G_{T}}, where P_{T} is the transmit power and G_{T} is the gain of each transmit antenna 114.

The two transmit signals combine coherently in the far field of the transmit array 110 into a single signal described by, s_{T}=s_{T}_{₁}+s_{T}_{₂}. Furthermore, the received signals at each of the two receive antennas 124 are defined by the equations, s_{R}_{₃}=A_{R}s_{T} exp(2pjR₃/l); and sR4=A_{R}s_{T} exp(2pjR₄/1), where R₃ and R₄ are the respective ranges from the target 180n to each receive antenna 124 as shown in FIG. 2 and where A_{R} is the signal amplitude defined by A_{R}=\sqrt{G_{R}}, where G_{R} is the gain of each of the two receive antennas 124.

### Steering the Transmit Signals

The transmit signals can be steered by introducing a spatial weight defined by n=exp(2pja). At the target 180n, the combined transmit signals are described by the following,

$$\begin{matrix}{s}_{{T}_{n}} = {s}_{{T}_{1}} + {ns}_{{T}_{2}} \\ = {A}_{T} exp ( 2 p j {R}_{1} / l ) + n {A}_{T} exp ( 2 p j {R}_{2} / l )\end{matrix}$$

Then, at each receive antenna 124

$${s}_{{R}_{3} n} = {A}_{R} {s}_{Tn} exp ( 2 p {jR}_{3} / l ) \qquad Received at Antenna 1$$

$${s}_{{R}_{4} n} = {A}_{R} {S}_{Tn} exp ( 2 p {jR}_{4} / l ) . \qquad Received at Antenna 2$$

Now match filter the returns at each receive antenna 124 with the normalized combined waveform and compute the power and phase of the received signal.

$${s}_{Nn} = \frac{1}{{A}_{T}} {s}_{Tn} = exp ( 2 p j {R}_{1} / l ) {W}_{1} + n exp ( 2 p j {R}_{2} / l ) {W}_{2}$$

Now choose nₘₐₓ such that

$${n}_{T} = {max}_{n} ( {s}_{Tn} \times {s}_{Nn}^{H} ) = 2 {A}_{T} + d ,$$

where δ is a small term associated with the cross correlation of W1 and W2. The match filter at receive antenna 1, the receive antenna 124 left of the receive normal vector 125, is defined by the following relationships,

$$\begin{matrix}{s}_{{R}_{3} n} \ddot{A} {s}_{Nn} = {A}_{R} {s}_{Tn} exp ( 2 p j {R}_{4} / l ) \ddot{A} {s}_{N n}^{H} \\ = {A}_{R} ( {s}_{Tn} \ddot{A} {s}_{N n}^{H} ) {s}_{{R}_{3} n} \ddot{A} {s}_{N n} \\ = {A}_{R} ( {s}_{Tn} \ddot{A} {s}_{N n}^{H} ) exp ( 2 p j {R}_{3} / l ) \\ = 2 {A}_{R} {A}_{T} exp ( 2 p j {R}_{3} / l )\end{matrix}$$

And similarly, the match filter at receive antenna 2, the receive antenna 124 right of the receive normal vector 125 is,

$$\begin{matrix}{s}_{{R}_{4} n} \ddot{A} {s}_{N n} = {A}_{R} {s}_{Tn} exp ( 2 p j {R}_{4} / l ) \ddot{A} {s}_{N n}^{H} \\ = {A}_{R} ( {s}_{Tn} \ddot{A} {s}_{N n}^{H} ) exp ( 2 p j {R}_{4} / l ) \\ = 2 {A}_{R} {A}_{T} exp ( 2 p j {R}_{4} / l )\end{matrix}$$

And it can be seen that the power for both received signals is as follows,

$${Ps}_{R} \text{?} = {s}_{R \text{?}} \times {s}_{R}^{⋆} \text{?} = 4 {P}_{T} {G}_{T} {G}_{R}$$

$$\text{?} \text{indicates text missing or illegible when filed}$$

and the phase for both received signals is as follows

$${j}_{1} = R ( {s}_{{R}_{3} n} \ddot{A} {W}_{1} ) = 2 p ( w + {R}_{3} / l )$$

$${j}_{2} = R ( {s}_{{R}_{3} n} \ddot{A} {W}_{2} ) = 2 p ( w + {R}_{4} / l )$$

The interferometer angle estimation is computed using the phase difference,

$$D j = \frac{2 p}{l} ( {R}_{3} - {R}_{4} ) = \frac{2 p {D}_{R}}{l} \times \frac{{R}_{3} - {R}_{4}}{{D}_{R}} ≫ \frac{2 p {D}_{R}}{l} sin ( {q}_{R} )$$

As the angle of incidence can be computed up to an ambiguity in the determined angle due to the spacing of the receive antennas 124,

$${q}_{R} = \frac{l \times D j}{2 p {D}_{R}}$$

and with

$${s}_{Dj} = \frac{1}{\sqrt{S N {R}_{HI}}}$$

it is demonstrated from the precision standard deviation,

$${s}_{q} = \frac{l}{2 p {D}_{R} \sqrt{S N {R}_{HI}}} = \frac{l}{2 p {D}_{R} \sqrt{4 S N {R}_{OI}}} = \frac{l}{4 p {D}_{R} \sqrt{S N {R}_{OI}}}$$

that the precision of HI is equivalent to the precision of OI for 2 transmit antennas 114 and 2 receive antennas 124.

In summary what is shown to this point is that if the orthogonal transmit signals are steered properly then a matched filter waveform can be defined that optimizes the power of the received signal at each receive antenna 124 and provides an estimate of the target angle θ_{R} at the receive array 120 using a conventional interferometer. The precision of this combination of using orthogonal waveforms on transmit with conventional interferometry on receive called Hybrid Interferometry is equivalent to Orthogonal Interferometry.

### Steering the Receive Signals

The question arises as to how the matched filter waveform can be defined at the receive array 120 without having to perform a scan or search of the transmit field from the transmit array 110 or SSTAE to define the optimal steering weight. Utilizing orthogonal waveforms on transmit makes it possible to determine this optimal weight from the receive array 120 or SSRAE in an efficient manner.

The first step is to match filter each received waveform with both transmitted (orthogonal) waveforms W₁ and W₂.

$$\begin{matrix}{s}_{{R}_{3}} Ä {W}_{1} = {A}_{R} {s}_{T} exp ( 2 pj {R}_{3} / l ) Ä {W}_{1} \\ = {A}_{R} ( {s}_{{T}_{1}} + {s}_{{T}_{2}} ) exp ( 2 pj {R}_{3} / l ) Ä {W}_{1} \\ = {A}_{R} ( {s}_{{T}_{1}} Ä {W}_{1} + {s}_{{T}_{2}} Ä {W}_{1} ) exp ( 2 pj {R}_{3} / l ) \\ = {A}_{R} ( {A}_{T} exp ( 2 pj {R}_{1} / l ) {W}_{1} Ä {W}_{1} + {A}_{T} exp ( 2 pj {R}_{2} / l ) {W}_{2} Ä {W}_{1} ) exp ( 2 pj {R}_{3} / l ) \\ = {A}_{R} {A}_{T} exp ( 2 pj {R}_{1} / l ) exp ( 2 pj {R}_{3} / l ) {W}_{1} Ä {W}_{1}\end{matrix}$$

$$\begin{matrix}{s}_{{R}_{3}} Ä {W}_{2} = {A}_{R} {s}_{T} exp ( 2 pj {R}_{3} / l ) Ä {W}_{2} \\ = {A}_{R} ( {s}_{{T}_{1}} + {s}_{{T}_{2}} ) exp ( 2 pj {R}_{3} / l ) Ä {W}_{2} \\ = {A}_{R} ( {s}_{{T}_{1}} Ä {W}_{2} + {s}_{{T}_{2}} Ä {W}_{2} ) exp ( 2 pj {R}_{3} / l ) \\ = {A}_{R} ( {A}_{T} exp ( 2 pj {R}_{1} / l ) {W}_{1} Ä {W}_{2} + {A}_{T} exp ( 2 pj {R}_{2} / l ) {W}_{2} Ä {W}_{2} ) exp ( 2 pj {R}_{3} / l ) \\ = {A}_{R} {A}_{T} exp ( 2 pj {R}_{2} / l ) exp ( 2 pj {R}_{3} / l ) {W}_{2} Ä {W}_{2}\end{matrix}$$

Now at the zero lag of the matched filter correlation the following is observed,

$$max ( {W}_{1} Ä {W}_{1} ) = {W}_{1} \times {W}_{1}^{H} = N ,$$

similarly

$$max ( {W}_{2} Ä {W}_{2} ) = {W}_{2} \times {W}_{2}^{H} = N ,$$

where N is the length code compression of the orthogonal waveforms.

Furthermore,

$$max ( abs ( {s}_{{R}_{3}} Ä {W}_{1} ) ) = 2 \times N \times {A}_{R} \times {A}_{T} and max ( abs ( {s}_{{R}_{3}} Ä {W}_{2} ) ) = 2 \times N \times {A}_{R} \times {A}_{T} .$$

The voltage at the zero lag of the two matched filters correlation is given by,

$$\begin{matrix}{v}_{{R}_{3}} = 2 N {A}_{R} {A}_{T} exp ( 2 pj {R}_{1} / l ) exp ( 2 pj {R}_{3} / l ) + d \\ {v}_{{R}_{4}} = 2 N {A}_{R} {A}_{T} exp ( 2 pj {R}_{2} / l ) exp ( 2 pj {R}_{4} / l ) + d\end{matrix}$$

Now for receive antenna 124 to the left of the receive normal vector 125, from V_{Rn}=V_{R}_{₃}+n_{R}V_{R}_{₄} where

$${n}_{R} = {max}_{n} ( {v}_{R n} \times {v}_{R n}^{H} )$$

it can be seen that n_{R}=n_{T} since in both cases they are defined by the following,

$${n}_{R} = {n}_{T} = {max}_{n} ( abs ( exp ( 2 pj {R}_{1} / l ) + n exp ( 2 pj {R}_{2} / l ) ) ) .$$

Thus, the steering can be applied on transmit or receive. However, by using orthogonal waveforms with low cross correlation, the steering weight can be computed using measured voltages of the matched filters at each receive antenna 124. It can also be observed that the steering weights computed at each receive antenna 124 are all equal. Thus, the weight only needs to be computed at one receive antenna 124 but can be applied to every antenna 124. The power of the received signals is 4G_{R}G_{T}P_{T} which is enhanced by the transmit gain and power. And the precision of HI is equivalent to OI for the 2 transmit antenna case.

### Multiple Transmit and Receive Antennas

For multiple transmit antennas 114 it will be necessary to determine multiple steering weights. For N_{T} number of transmit antennas 114 the steered signals can be expressed as follows,

$${s}_{T} = {s}_{{T}_{1}} + {n}_{2} {s}_{{T}_{2}} + K + {n}_{{N}_{T}} {s}_{{T}_{{N}_{T}}} .$$

The weights can be determined by computing the weights using antenna pairs. For four transmit antennas 114 the weights can be computed using the following process.

$${s}_{T} = {s}_{{T}_{1}} + {n}_{2} {s}_{{T}_{2}} + {n}_{3} {s}_{3} + {n}_{4} {s}_{{T}_{4}}$$

$${s}_{{T}_{11}} = {s}_{{T}_{1}} + {m}_{11} {s}_{{T}_{2}}$$

$${s}_{{T}_{12}} = {s}_{3} + {m}_{12} {s}_{{T}_{4}}$$

$${s}_{{T}_{21}} = {s}_{{T}_{11}} + {m}_{21} {s}_{{T}_{12}}$$

$$\begin{matrix}{s}_{T} = {s}_{{T}_{11}} + {m}_{12} {s}_{{T}_{12}} \\ = {s}_{{T}_{1}} + {m}_{11} {s}_{{T}_{2}} + {m}_{21} ( {s}_{{T}_{11}} + {m}_{12} {s}_{{T}_{12}} ) \\ = {s}_{{T}_{1}} + {m}_{11} {s}_{{T}_{2}} + {m}_{21} {s}_{{T}_{11}} + {m}_{21} {m}_{12} {s}_{{T}_{12}}\end{matrix}$$

However, it is also possible to use a gradient ascent algorithm on the multivariate objective function for N−1 variables.

$$\begin{matrix}{n}^{r} = [ \begin{matrix}{n}_{1} & {n}_{2} & {n}_{3} & K & {n}_{N}\end{matrix} ] & \\ {{n}^{r}}_{R} = {max}_{{n}^{r}} ( {v}_{{R}_{n}^{r}} \times {v}_{{R}_{n}^{r}}^{H} ) & ( Objective Function )\end{matrix}$$

For N_{T}>2 number of transmit antennas 114 the precision of the HI will be better than the precision of the OI.

$${s}_{q}^{HI} = \frac{l}{2 {N}_{T} p {D}_{R} \sqrt{S N {R}_{CI}}} ,$$

where D_{R} is the baseline distance between the two receive antennas 124.

It should be noted that a spatial weight can be applied on receive for two antennas thereby increasing the receive antenna gain by a factor of two. However, by combining the two receive signals it will not be possible to implement interferometry, but the combination could be used to increase sensitivity for target detection.

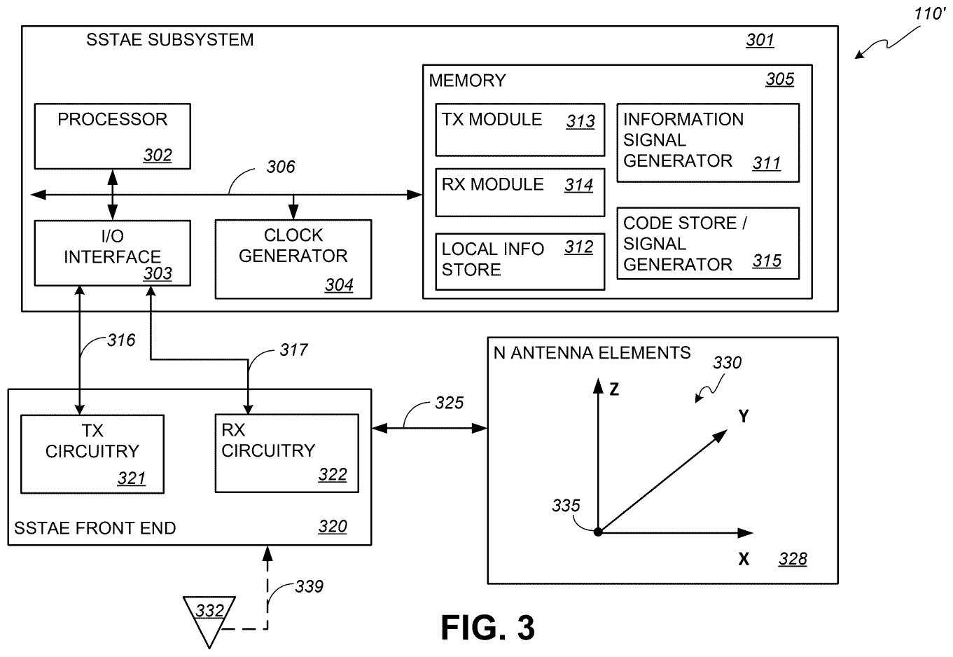

FIG. 3 illustrates an example embodiment of the transmit array 110 introduced in FIG. 2. In the illustrated embodiment, the transmit array 110′ includes a SSTAE subsystem 301, SSTAE front end 320 and N antenna elements 328. As indicated, the N antenna elements 328 define a three-dimensional coordinate system 330 with an origin 335 at the centroid of the N antenna elements 328. The SSTAE subsystem 301 includes a processor 302, input/output (I/O) interface 303, clock generator 304 and memory 305 coupled to one another via a bus or local interface 306. The bus or local interface 306 can be, for example but not limited to, one or more wired or wireless connections, as is known in the art. The bus or local interface 306 may have additional elements, which are omitted for simplicity, such as controllers, buffers (caches), drivers, repeaters, and receivers (e.g. circuit elements), to enable communications. In addition, the bus or local interface 306 may include address, control, power and/or data connections to enable appropriate communications among the components.

The processor 302 executes software (i.e., programs or sets of executable instructions), particularly the instructions in the information signal generator 311, TX module 313, RX module 314, and code store/signal generator 315 stored in the memory 305. The processor 302 in accordance with one or more of the mentioned generators or modules may retrieve and buffer data from the local information store 312. The processor 302 can be any custom made or commercially available processor, a central processing unit (CPU), an auxiliary processor among several processors associated with the SSTAE subsystem 301, a semiconductor-based microprocessor (in the form of a microchip or chip set), and application specific integrated circuit (ASIC) or generally any device for executing instructions.

The clock generator 304 provides one or more periodic signals to coordinate data transfers along bus or local interface 306. The clock generator 304 also provides one or more periodic signals that are communicated via the I/O interface 303 over connection 316 to the TX circuitry 321. In addition, the clock generator 304 also provides one or more periodic signals that are communicated via the I/O interface 303 over connection 317 to the RX circuitry 322. The one or more periodic signals forwarded to the SSTAE front end 320 enable the transmit array 110′ to coordinate the transmission of the N uniquely coded signals to the N antenna elements 328 via the connections 325 and the reception of (optional) informative signals via the N antenna arrays 328 or a dedicated data link antenna 332 communicatively coupled to the SSTAE front end 320 by the optional connection 339. The I/O interface 303 includes controllers, buffers (caches), drivers, repeaters, and receivers (e.g. circuit elements), to enable communications between the SSTAE subsystem 301 and the SSTAE front end 320.

The memory 305 can include any one or combination of volatile memory elements (e.g., random-access memory (RAM), such as dynamic random-access memory (DRAM), static random-access memory (SRAM), synchronous dynamic random-access memory (SDRAM), etc.) and non-volatile memory elements (e.g., read-only memory (ROM)). Moreover, the memory 305 may incorporate electronic, magnetic, optical, and/or other types of storage media. Note that the memory 305 can have a distributed architecture, where various components are situated remote from one another, but can be accessed by the processor 302.

The code store/signal generator 315 includes executable instructions and data that when buffered and executed by the processor 302 generate and forward a set of T signals that are encoded or arranged in a manner that enable a receiver of the T signals, such as, the receive array 120 to separately identify each of the T signals at a location separate from the transmit array 110′. The TX module 313 includes executable instructions and data that when buffered and executed by the processor 302 enable the SSTAE subsystem 301 to communicate a set of uniquely identifiable signals to a spatially distributed architecture of N antenna elements 328, where N is a positive integer greater than or equal to two, the arrangement of the N antenna elements 328 defining the coordinate system 330. The TX module 313 includes executable instructions and data that when buffered and executed by the processor 302 enable the SSTAE subsystem 301 to receive reflected versions of the set of uniquely identifiable signals transmitted from the transmit array 110′ and reflected by the target 180n.

The information signal generator 311 includes executable instructions and data that when buffered and executed by the processor 302 operates on electrical measurements made in the SSTAE front end 320 in response to the reflections of the T uniquely coded signals transmitted by the N antenna elements 328, where P is a positive integer equal to or less than the N antenna elements 328. Alternatively, the information signal generator 311 includes executable instructions and data that when buffered and executed by the processor 302 generate and forward a signal or signals that communicate a position and motion (if any) of the target 180n in the coordinate system 330. The signal or signals are based on a respective time and phase of reflected versions of the T uniquely coded signals and an angular position and a range of the target 180n relative to the origin 335 of the coordinate system 330.

In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

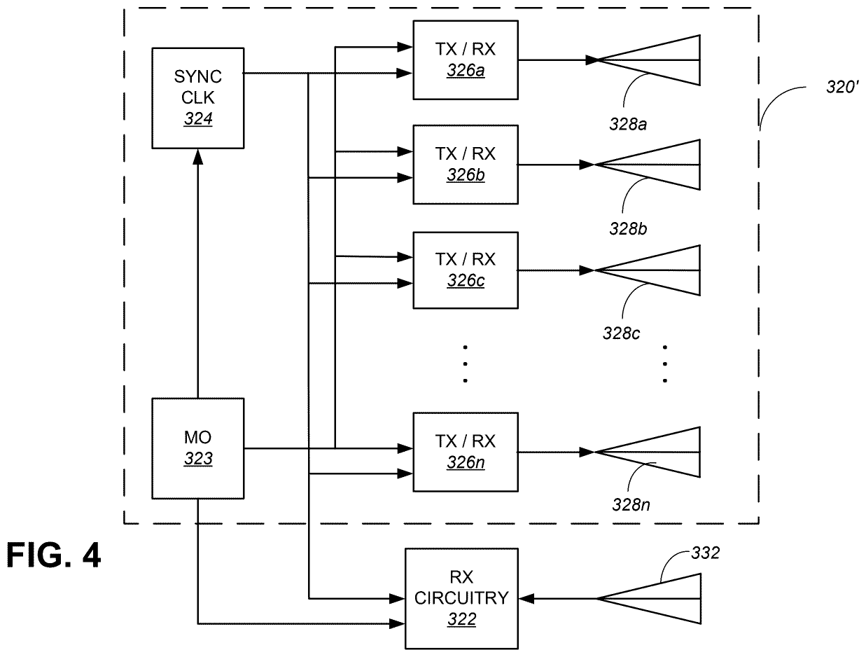

FIG. 4 illustrates an alternative embodiment of the SSTAE front end 320′ introduced in FIG. 3. In the illustrated embodiment, the SSTAE front end 320′ includes receive circuitry integrated with the transmit circuitry as in a transceiver configuration. The SSTAE 320′ includes a master oscillator (MO) 323, a synchronization clock (SYNC CLK) 324, a set of transmit-receive signal generators 326a-326n and a respective set of antennas 328a-328n. The master oscillator 323 generates a common carrier frequency that is distributed to each of the transmit-receive signal generators 326a-326n and to the synchronization clock 324. The synchronization clock 324 adjusts the common carrier frequency and forwards respective codes to each of the respective transmit-receive signal generators 326a-326n. The synchronization clock 324 may divide the common carrier frequency by a factor before forwarding the codes. In turn, the transmit-receive signal generators 326a-326n modulate the common carrier frequency with the respective codes and convert the common carrier frequency to a radio frequency. An output of each of the transmit-receive signal generators 326a-326n is coupled to an input of a respective antenna 328a-328n. The antennas 328 receive the electrical signals produced by the transmit-receive signal generators 326a-326n and convert the coded electrical signals to an over-the-air electromagnetic wave.

A reflected version of each of the T unique transmit signals may be received at each of the respective antennas 328a-328n. The antennas 328a-328n convert the radio-frequency electromagnetic waves to respective electrical signals which are communicated to the transmit-receive signal generators 326a-326n where the respective electrical signals are demodulated, sampled, converted and match filtered before being communicated to processor 302.

As illustrated in FIG. 4, the SSTAE front end 320′ may be coupled via the sync clock 324 and the to receiver circuitry 322 and an antenna 332 to providing a data link or information channel from the receive array 120 to the transmit array 110. The data link may be provided to communicate the spatial weighting factors identified in a circuit assembly coupled to the receive array 120. Such an information channel is optional if the spatially adjusted weighting factors are determined when the reflected versions of the received T unique waveforms are at a respective maximum signal power level.

Although the illustrated embodiment shows the transmit-receive signal generators 326a-326n and antennas 328a-328n in a one-to-one relationship, two or more of the transmit-receive signal generators 326a-326n may share an antenna. Preferably, the transmit-receive signal generators 326a-326n are augmented by a digital signal processor (not shown) that spatially directs the set of T uniquely coded transmit signals in an environment surrounding the transmit array 110. Such directivity or beamforming techniques controllably direct the radio-frequency electromagnetic energy in a predictable way. Accordingly, a control system (not shown) or other source of information identifying a region of interest in the environment may direct the SSTAE front end 320′ to send the set of T uniquely coded transmit signals in the general direction of a target or target 180n. Similarly, the control system or other source of information identifying a region where a reflective target 180n is expected to be located may direct the SSTAE front end 320′ to send the set of T uniquely coded transmit signals in the general direction of the target 180n.

The set of T uniquely coded signals produced by the transmit-receive signal generators 326a-326n are preferably orthogonal, or nearly orthogonal, to each other. This orthogonal coding enables the individual signals to be distinguished from one another at the receive array 120. There are common signal coding and signal processing techniques that are suitable for this purpose, including, for example, time-division multiplexing, frequency-division multiplexing, code-division multiplexing, and polarization coding. For some environments a combination of one or more of these coding and signal processing techniques can be used to generate a set of signals that do not interfere with one another and are thus separately identifiable.

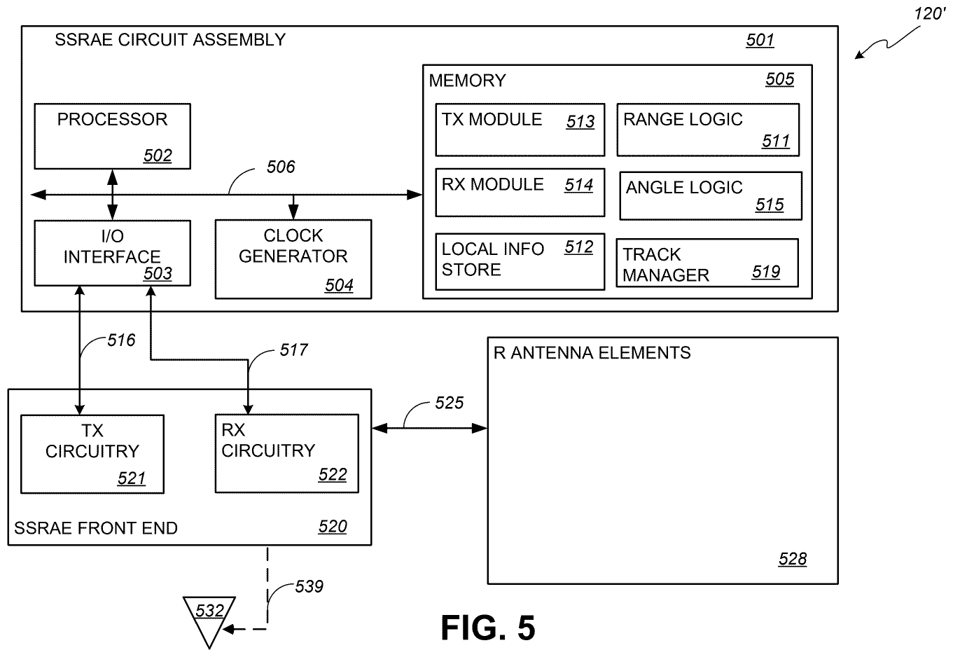

FIG. 5 illustrates an example embodiment of the receive array 120 introduced in FIG. 2. In the illustrated embodiment, the receive array 120′ includes a SSRAE circuit assembly 501, SSRAE front end 520 and R antenna elements 528. The SSRAE subsystem 501 includes a processor 502, input/output (I/O) interface 503, clock generator 504 and memory 505 coupled to one another via a bus or local interface 506. The bus or local interface 506 can be, for example but not limited to, one or more wired or wireless connections, as is known in the art. The bus or local interface 506 may have additional elements, which are omitted for simplicity, such as controllers, buffers (caches), drivers, repeaters, and receivers (e.g. circuit elements), to enable communications. In addition, the bus or local interface 506 may include address, control, power and/or data connections to enable appropriate communications among the components.

The processor 502 executes software (i.e., programs or sets of executable instructions), particularly the instructions in the range logic 511, TX module 513, RX module 514, angle of arrival determination or angle logic 515 stored in the memory 505. The processor 502 in accordance with one or more of the mentioned logic stores or modules may retrieve and buffer data from the local information store 512. The processor 502 can be any custom made or commercially available processor, a central processing unit (CPU), an auxiliary processor among several processors associated with the SSRAE circuit assembly 301, a semiconductor-based microprocessor (in the form of a microchip or chip set), and application specific integrated circuit (ASIC) or generally any device for executing instructions.

The clock generator 504 provides one or more periodic signals to coordinate data transfers along bus or local interface 506. The clock generator 504 may include logic for synchronizing the phase of one or more of the T unique waveforms received at the R antenna elements 528 to the local clock. The clock generator 504 also provides one or more periodic signals that are communicated via the I/O interface 503 over connection 516 to the TX circuitry 521. In addition, the clock generator 504 also provides one or more periodic signals that are communicated via the I/O interface 503 over connection 517 to the RX circuitry 522. The one or more periodic signals forwarded to the SSRAE front end 520 enable the receive array 120′ to coordinate the transmission of the T uniquely coded signals to the R antenna elements 528 via the connections 525 and the transmission of (optional) informative signals via the R antenna elements 528 or a dedicated data link antenna 532 communicatively coupled to the SSRAE front end 520 through the optional connection 539. The I/O interface 503 includes controllers, buffers (caches), drivers, repeaters, and receivers (e.g. circuit elements), to enable communications between the SSRAE circuit assembly 501 and the SSRAE front end 520.

The memory 505 can include any one or combination of volatile memory elements (e.g., random-access memory (RAM), such as dynamic random-access memory (DRAM), static random-access memory (SRAM), synchronous dynamic random-access memory (SDRAM), etc.) and non-volatile memory elements (e.g., read-only memory (ROM)). Moreover, the memory 505 may incorporate electronic, magnetic, optical, and/or other types of storage media. Note that the memory 505 can have a distributed architecture, where various components are situated remote from one another, but can be accessed by the processor 502.

The range logic 511 includes executable instructions and data that when buffered and executed by the processor 502 determine a sequence of range resolution cells over a period or window in response to a set of decoded T waveforms incident at the R antenna elements 528 of the receiver array 120′. The range logic 511 when executed in the processor 502 performs a signal processing routine responsive to the set of T waveforms to determine a range or distance between the target 180n and each of the R antenna elements 528.

The angle logic 515 includes executable instructions and data that when buffered and executed by the processor 502 use relative phase information from the R combined waveforms incident at the R antenna elements 528 to determine an angle of arrival of a target reflected signal with respect to the normal vector 125 extending orthogonally from the receive plane 121.

Furthermore, the angle logic 515 may be arranged to use the respective electrical signals received at the I/O interface 503 to define at least two sets of R weights to create at least one or more pairs of sum and difference weights for applying one or more monopulse ratios of a difference divided by a sum to determine the angle of arrival of the target with respect to the normal vector 125 extending orthogonally from the receive plane 121.

In addition, the SSRAE circuit assembly 501 is arranged to use a monopulse SSTAE architecture and at least a single SSRAE antenna to identify an angle of arrival of the target signal with respect to the normal vector 115 extending orthogonally from the transmit plane 111.

When the SSTAE 110 and the SSRAE 120 are not co-located, the SSRAE circuit assembly 501 is arranged to use the set of T weights from the T combined waveforms received at each of at least one of the R members of the SSRAE to determine an angle of arrival of the SSTAE combined transmit waveforms signal with respect to the normal vector 115 extending orthogonally from the transmit plane 111.

When the respective electrical signals received at the I/O interface 503 include at least one target signal, the SSRAE circuit assembly 501 is arranged to use the unique waveforms and the set of T weights from the T combined waveforms received at each of at least one of the R members of the SSRAE to determine an angle of arrival of the target reflected signal with respect to the normal vector 115 extending orthogonally from the transmit plane 111. In this regard, the SSRAE circuit assembly 501 uses the set of R weights from the T combined waveforms received at each of at least two of the R members of the SSRAE to determine an angle of arrival of a signal with respect to the normal vector 125 extending orthogonally from the receive plane 121.

Alternatively, the SSRAE circuit assembly 501 can be arranged to use the set of R weights from the T combined waveforms received at each of at least two of the R members of the SSRAE to manipulate that SSRAE beam pattern with respect to the normal vector 125 extending orthogonally from the receive plane 121.

The SSRAE circuit assembly 501 can also be configured to use the T-unique waveforms transmitted by the T members of the SSTAE and the separate two-way phase rotations of a reflected target signal to each of the R members of the SSRAE to provide the angle of arrival of the target with respect to the normal vector 125 extending orthogonally from the receive plane 121.

The TX module 513 includes executable instructions and data that when buffered and executed by the processor 502 enable the SSRAE circuit assembly 501 to communicate a set of weights or factors to the SSTAE front end 320 via the connection 539 and the antenna 532. The set or weights or factors are communicated to the SSTAE front end 320 to provide transmit signal beam in the direction of a moving target 180n.

In this regard, the transmit signals from the SSTAE 110 are spatially weighted to direct the transmit signals with waveform coherence with respect to the normal vector 115 extending orthogonally from the transmit plane 111.

Alternatively or additionally, the incident signals at the SSRAE 120 are spatially weighted to increase sensitivity with respect to the normal vector 125 extending orthogonally from the receive plane 121.

When the respective electrical signals received at the I/O interface 503 of the SSRAE circuit assembly 501 include at least one target signal, the SSRAE circuit assembly 501 uses the unique waveforms and voltages determined from the electrical signals to define one or more pairs of sum and difference phase weightings applied to the voltages at each of the T members of the SSTAE resulting from the T combined waveforms at each R member for defining one or more monopulse ratios of a difference beam voltage divided by a sum beam voltage that determines the angle of arrival of the target signal with respect to the normal vector 115 extending orthogonally from the transmit plane 111.

Alternatively, when the respective electrical signals received at the I/O interface 503 of the SSRAE circuit assembly 501 include at least one target signal, the SSRAE circuit assembly 501 uses voltages determined from the electrical signals to define one or more pairs of sum and difference phase weightings applied to the voltages at each of the R members of the SSRAE resulting from the T combined waveforms at each R member for defining one or more monopulse ratios of a difference beam voltage divided by a sum beam voltage that determines the angle of arrival of the target with respect to the normal vector 125 extending orthogonally from the receive plane 121.

The track manager 519 includes executable instructions and data that when buffered and executed by the processor 502 coordinates both transmit and receive nodes to increase sensitivity and resolve analog and digital interferometer grating lobes with monopulse information.

The track manager 519 is arranged to pair a defined mode of operation of the circuit assembly with a detected target, wherein the defined mode of operation is selected from the group of modes consisting of a maximally cohered array monopulse, maximally cohered array interferometer, orthogonal interferometry, and conventional interferometry, wherein antenna architectures enable the various modes of monopulse and interferometry.

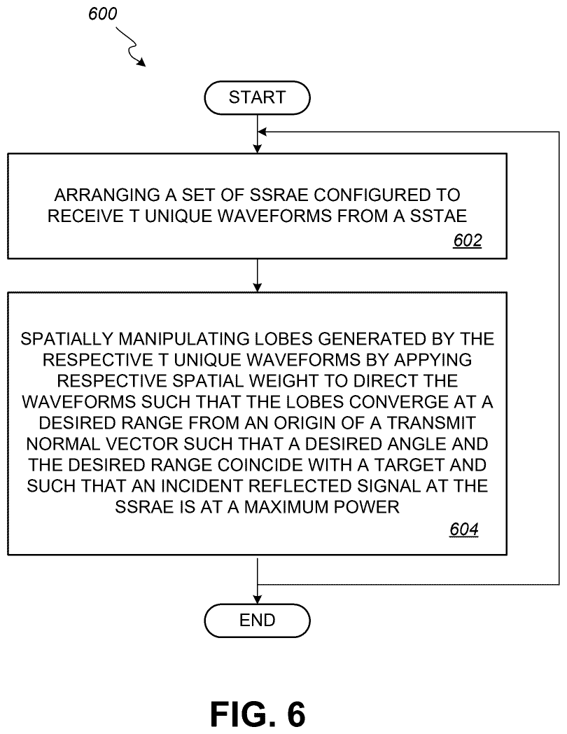

FIG. 6 is a flow diagram illustrating a method 600 for deploying a hybrid interferometer. Method 600 begins as indicated in block 602 by arranging a set of SSRAE configured to receive T unique waveforms from a set of SSTAE. Thereafter, as shown in block 604 lobes or nodes generated by the respective T unique waveforms are spatially manipulated by applying a weight factor to direct the waveforms such that the lobes converge at a desired range from an origin of a transmit normal vector such that a desired angle and the desired range converge or coincide with a target and such that an incident reflected signal at the SSRAE is at a maximum signal power.

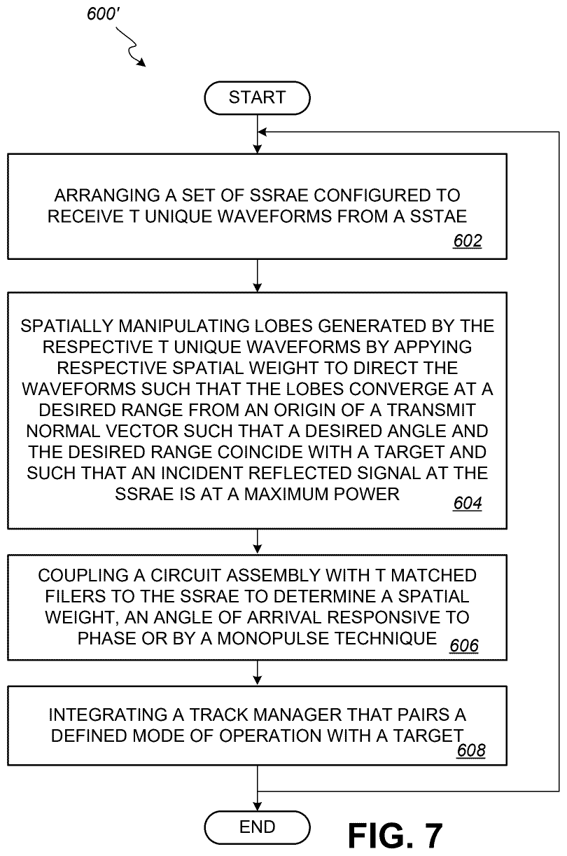

FIG. 7 is a flow diagram illustrating an alternative method 660′ for using a hybrid interferometer. The method 600′ begins with block 602 by arranging a set of SSRAE configured to receive T unique waveforms from a set of SSTAE. Thereafter, as shown in block 604 lobes or nodes generated by the respective T unique waveforms are spatially manipulated by applying a weight factor to direct the waveforms such that the lobes converge at a desired range from an origin of a transmit normal vector such that a desired angle and the desired range converge or coincide with a target and such that an incident reflected signal at the SSRAE is at a maximum signal power. Next, as indicated in block 606 a circuit assembly is coupled to or otherwise integrated with the SSRAE, the circuit assembly includes a matched filter to determine a spatial weight, as well as logic for determining an angle of arrival responsive to phase measurements or by applying a monopulse technique. In addition, as illustrated in block 608 a track manager is integrated to pair a defined mode of operation with a detected target.

### CONCLUSIONS

A Hybrid Interferometer 100 is presented that uses orthogonal transmit waveforms from two or more distributed transmit antennas 114 and one or more receive antennas 124. The advantages of HI include enhanced precision, increased sensitivity, improved spatial antenna patterns, and lower time sidelobe performance. Specifically, the advantages are as follows.

HI has equivalent precision performance to OI for two transmit antennas 114 and two receive antennas 124 assuming equal gain and power in each transmit antenna 114.

HI has better precision performance than OI for more than two transmit antennas 114. The precision performance scales inversely to the number of transmit antennas 114.

The target SNR increases proportionally as the number of transmit antennas 114 providing the capability to detect a target 180n at longer range and track the detected target 180n using interferometry for improved angle precision.

The sensitivity can be further increased by implementing spatial weight on the receive antennas 124 for even longer-range target detection however interferometry is not possible when the receive signals are combined into one coherent signal.

The spatial weighting achieves full transmit waveform coherence that provides a single coherent transmit beam that can be orders of magnitude smaller than the interferometer array antenna beams.

Lower time sidelobes due the coherence of the orthogonal waveforms.

The spatial weighting computed using the receive waveforms can be applied on the transmit waveforms to provide beam steering toward the target 180n.

1. A system for enhancing radar sensitivity for conventional RF interferometric applications using transmit elements, the system comprising:
a set of spatially separated receive antenna elements (SSRAE), the SSRAE having at least R members, where R is a positive integer greater than or equal to one, the SSRAE receiving T unique waveforms transmitted from a set of spatially separated transmit antenna elements (SSTAE), the SSTAE having at least T members transmitting T unique waveforms, respectively, where T is a positive integer greater than or equal to two; and
a circuit assembly electrically coupled to the set of SSRAE, the set of SSRAE providing respective electrical signals responsive to the T unique waveforms, the circuit assembly operating on the respective electrical signals to define a set of T weights to apply to the T unique waveforms to create a combined waveform from the T received waveforms at each of the R receive antennas,
wherein the R combined waveforms are the coherent sum of the T waveforms at each of the R members of the SSRAE.

2. The system of claim 1,
wherein the SSRAE defines a receive plane with a normal vector extending orthogonally from the receive plane; and
wherein the SSTAE defines a transmit plane with a respective normal vector extending orthogonally from the transmit plane.

3. The system of claim 1, wherein the circuit assembly determines the time of arrival of the combined waveform at each SSRAE,
wherein the circuit assembly determines a sequence of range resolution cells over a window, responsive to the set of T waveforms; and
wherein the circuit assembly performs a signal processing routine responsive to the set of T waveforms.

4. The system of claim 2, wherein when the respective electrical signals include at least one target signal, the circuit assembly uses phase information from the R combined waveforms to determine an angle of arrival of the target signal with respect to the normal vector extending orthogonally from the receive plane.

5. The system of claim 4, wherein the respective electrical signals define at least two sets of R weights to create at least one or more pairs of sum and difference weights for applying one or more monopulse ratios of a difference divided by a sum to determine the angle of arrival of the target with respect to the normal vector extending orthogonally from the receive plane.

6. The system of claim 2, wherein the circuit assembly uses a monopulse SSTAE architecture and at least a single SSRAE antenna to identify an angle of arrival of the target signal with respect to the normal vector extending orthogonally from the transmit plane.

7. The system of claim 6, wherein the circuit assembly coordinates both transmit and receive nodes to increase sensitivity and resolve analog and digital interferometer grating lobes with monopulse information.

8. The system of claim 2, wherein the SSRAE and the SSTAE are not collocated and the circuit assembly uses the set of T weights from the T combined waveforms received at each of at least one of the R members of the SSRAE to determine an angle of arrival of the SSTAE combined transmit waveforms signal with respect to the normal vector extending orthogonally from the transmit plane.

9. The system of claim 2, wherein when the respective electrical signals include at least one target signal, the circuit assembly uses the unique waveforms and the set of T weights from the T combined waveforms received at each of at least one of the R members of the SSRAE to determine an angle of arrival of the target with respect to the normal vector extending orthogonally from the transmit plane.

10. The system of claim 9, wherein the circuit assembly uses the set of R weights from the T combined waveforms received at each of at least two of the R members of the SSRAE to determine an angle of arrival of a signal with respect to the normal vector extending orthogonally from the receive plane.

11. The system of claim 9, wherein the circuit assembly uses the set of R weights from the T combined waveforms received at each of at least two of the R members of the SSRAE to manipulate that SSRAE beam pattern with respect to the normal vector extending orthogonally from the receive plane.

12. The system of claim 2, wherein the circuit assembly uses the T-unique waveforms transmitted by the T members of the SSTAE and the separate two-way phase rotations of a target signal to each of the R members of the SSRAE to provide the angle of arrival of the target with respect to the normal vector extending orthogonally from the receive plane.

13. The system of claim 2, further comprising:
a track manager arranged to pair a defined mode of operation of the circuit assembly with a detected target, wherein the defined mode of operation is selected from the group of modes consisting of a maximally cohered array monopulse, maximally cohered array interferometer, orthogonal interferometry, and conventional interferometry, wherein antenna architectures enable the various modes of monopulse and interferometry.

14. The system of claim 1, wherein the SSRAE are not co-located with the SSTAE.

15. The system of claim 1, wherein the SSRAE are co-located with the SSTAE.

16. The system of claim 2, wherein the transmit signals from the SSTAE are spatially weighted to direct the transmit signals with waveform coherence with respect to the normal vector extending orthogonally from the transmit plane.

17. The system of claim 2, wherein the incident signals at the SSRAE are spatially weighted to increase sensitivity with respect to the normal vector extending orthogonally from the receive plane.

18. The system of claim 14, wherein spatial weights determined by the circuit assembly are communicated to the SSTAE to provide transmit signal beam steering toward the target.

19. The system of claim 2, wherein when the respective electrical signals include at least one target signal, the circuit assembly uses the unique waveforms and voltages determined from the electrical signals to define one or more pairs of sum and difference phase weightings applied to the voltages at each of the T members of the SSTAE resulting from the T combined waveforms at each R member for defining one or more monopulse ratios of a difference beam voltage divided by a sum beam voltage that determines the angle of arrival of the target signal with respect to the normal vector extending orthogonally from the transmit plane.

20. The system of claim 2, wherein when the respective electrical signals include at least one target signal, the circuit assembly uses voltages determined from the electrical signals to define one or more pairs of sum and difference phase weightings applied to the voltages at each of the R members of the SSRAE resulting from the T combined waveforms at each R member for defining one or more monopulse ratios of a difference beam voltage divided by a sum beam voltage that determines the angle of arrival of the target with respect to the normal vector extending orthogonally from the receive plane.

21. A method, comprising:
arranging a set of spatially separated receive antenna elements (SSRAE), the SSRAE having at least R members, where R is a positive integer greater than or equal to one, the SSRAE receiving T unique waveforms transmitted from a set of spatially separated transmit antenna elements (SSTAE), the SSTAE having at least T members transmitting T unique waveforms, respectively, where T is a positive integer greater than or equal to two; and
spatially manipulating lobes generated by the respective T unique waveforms,
wherein spatially manipulating lobes generated by the respective T unique waveforms includes applying a respective spatial weight to direct the respective T unique waveforms with respect to a transmit normal vector extending orthogonally from a plane defined by the SSTAE,
wherein the respective spatial weight is applied in a manner that directs the respective lobes to a desired angle with respect to the transmit normal vector extending from the plane defined by the SSTAE and such that the lobes converge at a desired range from an origin of the transmit normal vector,
wherein when the desired angle and the desired range coincide with a location of a target in a transmit field of view, a power of a respective receive signal incident at the SSRAE is at a maximum.

22. The method of claim 21, further comprising:
coupling a circuit assembly to the set of SSRAE, the set of SSRAE providing respective electrical signals responsive to the T unique waveforms, the circuit assembly operating on the respective electrical signals to define a range from the target to an origin of a normal vector extending from the plane defined by the SSRAE and an estimate of an angle of incidence with respect to a receive normal vector extending from the plane defined by the SSRAE.

23. The method of claim 21, further comprising:
coupling a circuit assembly to the set of SSRAE,
wherein spatially manipulating lobes generated by the respective T unique waveforms is responsive to a determination of a transmit spatial weight from a reflected version of the T unique waveforms received at one of the set of SSRAE, and
arranging the circuit assembly with up to T matched filters, wherein the transmit spatial weight is a function of an output of the matched filters.

24. The method of claim 23, further comprising:
using voltage outputs of the up to T matched filters at each R member of the SSRAE to determine an angle of arrival interferometrically,
wherein the angle of arrival is responsive to phase measurements.

25. The method of claim 23, further comprising:
using voltage outputs of the up to T matched filters at each R member of the SSRAE to determine an angle of arrival with a monopulse technique,
wherein the angle of arrival is responsive to sum and difference ratios of voltages.

26. The method of claim 23, further comprising:
integrating or communicatively coupling a track manager to the circuit assembly, the track manager configured to pair a defined mode of operation of the circuit assembly with a detected target, wherein the defined mode of operation is selected from the group of modes consisting of a maximally cohered array monopulse, maximally cohered array interferometer, orthogonal interferometry, and conventional interferometry, wherein antenna architectures enable the various modes of monopulse and interferometry.
